(19) United States
(12) Patent Application Publication
(10) Pub. No.: US 2020/0012847 A1
(43) Pub. Date: Jan. 9, 2020

(54) OBJECT DETECTION APPARATUS, CONTROL METHOD IMPLEMENTED BY OBJECT DETECTION APPARATUS, AND NON-TRANSITORY COMPUTER-READABLE STORAGE MEDIUM FOR STORING PROGRAM

(71) Applicant: Fujitsu Limited, Kawasaki-shi (JP)

(72) Inventors: Akihito Yoshii, Setagaya (JP); Toshikazu Kanaoka, Kawasaki (JP); Toru Kamiwada, Kawasaki (JP)

(73) Assignee: Fujitsu Limited, Kawasaki-shi (JP)

(21) Appl. No.: 16/573,501

(22) Filed: Sep. 17, 2019

Related U.S. Application Data
(63) Continuation of application No. PCT/JP2017/012047, filed on Mar. 24, 2017.

(51) Int. Cl. G06K 9/00; G06T 7/50; G06K 9/20; G06T 7/70

(52) U.S. Cl. CPC G06K 9/00201; G06T 7/70; G06K 9/209; G06T 7/50

(57) ABSTRACT

An object detection apparatus includes: a camera configured to capture an image of an object; one or more of sensor devices each of which is configured to detect an environmental change; and a processor configured to (a): execute a determining process that includes, when any one of the one or more of sensor devices detects an environmental change, detecting a search starting point of the object based on at least one of a time corresponding to the detection and detection information from the sensor device, (b): execute an entry registering process that includes registering an entry with reference information when the object is detected, the entry including at least one of the time and the detection information and a direction in which the object is detected, wherein the determining process is configured to determine the direction toward which the camera is to be turned based on the reference information.

### CROSS-REFERENCE TO RELATED APPLICATION

This application is a continuation application of International Application PCT/JP2017/012047 filed on Mar. 24, 2017 and designated the U.S., the entire contents of which are incorporated herein by reference.

### FIELD

The embodiments discussed herein are related to an object detection apparatus, a control method implemented by the object detection apparatus, and a non-transitory computer-readable storage medium storing a program.

### BACKGROUND

In recent years, apparatuses such as robots and home appliances that detect the presence of a human by using a camera have widely been used. Such an apparatus detecting the presence of a human may actively serve or operate on the detected human without waiting for an instruction from a user of the apparatus.

Examples of the related art include Japanese Laid-open Patent Publication No. 2000-148972, Japanese Laid-open Patent Publication No. 2006-134218, and Japanese Laid-open Patent Publication No. 2011-259384.

### SUMMARY

According to an aspect of the embodiments, an object detection apparatus includes: a camera configured to capture an image of an object; one or more of sensor devices, each of the one or more of sensor devices being configured to detect an environmental change; and a processor configured to (a): execute a determining process that includes, in a case where any one of the one or more of sensor devices detects an environmental change, detecting a search starting point of the object based on at least one of a time corresponding to the detection and detection information from the sensor device, the search starting point corresponding to a direction toward which the camera is turned, (b): execute an entry registering process that includes registering an entry with reference information when the object is detected, the entry including at least one of the time and the detection information and a direction in which the object is detected, wherein the determining process is configured to determine the direction toward which the camera is to be turned based on the reference information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram illustrating an example of an object detection apparatus according to a first embodiment;

FIG. 2 is a second diagram illustrating the example of the object detection apparatus according to the first embodiment;

FIG. 3 is a diagram illustrating an example of a hardware configuration of the object detection apparatus according to the first embodiment;

FIG. 4 is a flowchart illustrating an example of processing to be executed by the object detection apparatus according to the first embodiment;

FIG. 5 is a diagram illustrating an example of a reference information table according to the first embodiment;

FIG. 6 is a flowchart illustrating details of a process according to the first embodiment;

FIG. 7 is a diagram illustrating an example including a plurality of entries that are grouped according to the first embodiment;

FIG. 8 is a diagram for explaining direction ranges;

FIG. 9 is a diagram illustrating an example of a direction counter according to the first embodiment;

FIG. 10 is a diagram illustrating an example of an object detection apparatus according to a second embodiment;

FIG. 11 is a diagram illustrating an example of a hardware configuration of the object detection apparatus according to the second embodiment;

FIG. 12 is a first flowchart illustrating an example of processing to be executed by the object detection apparatus according to the second embodiment;

FIG. 13 is a diagram illustrating an example of a reference information table according to the second embodiment;

FIG. 14 is a flowchart illustrating details of a process according to the second embodiment;

FIG. 15 is a diagram illustrating an example including a plurality of entries that are grouped according to the second embodiment;

FIG. 16 is a second flowchart illustrating an example of processing to be executed by the object detection apparatus according to the second embodiment;

FIG. 17 is a diagram illustrating an example of an object detection apparatus according to a third embodiment;

FIG. 18 is a first flowchart illustrating an example of processing to be executed by the object detection apparatus according to the third embodiment;

FIG. 19 is a diagram illustrating an example including a plurality of entries that are grouped according to the third embodiment;

FIG. 20 is a second flowchart illustrating an example of processing to be executed by the object detection apparatus according to the third embodiment;

FIG. 21 is a diagram illustrating an example of an object detection apparatus according to a fourth embodiment; and

FIG. 22 is a flowchart illustrating an example of processing to be executed by the object detection apparatus according to the fourth embodiment.

### DESCRIPTION OF EMBODIMENTS

A camera has a predetermined field of view based on an angle of view of a lens mounted thereon, and it is difficult to detect a human outside the field of view if the camera is not moved. Therefore, in the apparatus as described above, scanning is performed by changing the direction of the camera to search a human. This means time is required for detecting a human. The time for detecting an object is desirably reduced so that such an apparatus may provide a service or perform an operation on a human in a timely manner.

According to one aspect of embodiments, it is an object to provide an object detection apparatus, an object detection method and a program that may reduce time for detecting an object.

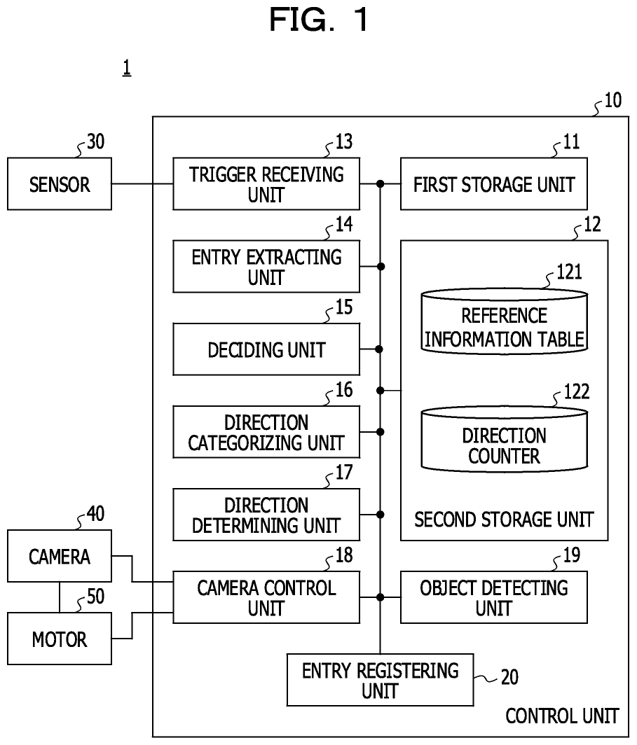

Embodiments will be specifically described below with reference to FIGS. 1 to 22. In the following descriptions, a human is illustrated as an object to be detected by an object detection apparatus. However, embodiments are also applicable to objects such as an animal other than a human.

### First Embodiment

A first embodiment will be described below with reference to FIGS. 1 to 9.

FIG. 1 is a first diagram illustrating an example of an object detection apparatus according to the first embodiment. As illustrated in FIG. 1, an object detection apparatus 1 includes a control unit 10, a sensor 30, a camera 40, and a motor 50. The control unit 10 is connected with the sensor 30, the camera 40 and the motor 50. The object detection apparatus 1 is a communication robot that communicates with a human, for example.

The control unit 10 is a computer for executing processing that detects the presence of a human.

The sensor 30 is a sensor that detects a change in a surrounding environment. The object detection apparatus 1 starts the processing that detects the presence of a human by taking the opportunity of detection of a change in a surrounding environment by the sensor 30. The sensor 30 is communicably connected with the control unit 10 via a Universal Serial Bus (USB) or a microcomputer, for example. The sensor 30 is, for example, a microphone that detects a sound, an illuminance sensor that detects an illuminance change, or a vibration sensor that detects vibrations. The sensor 30 may not identify the direction of approach of an object such as a human according to this embodiment. When the sensor 30 detects that a change has occurred in a surrounding environment, the sensor 30 transmits a trigger that notifies the detection to the control unit 10.

The camera 40 is an apparatus that captures an image of a surrounding of the object detection apparatus 1. The camera 40 rotates to change the direction of the camera 40 by 360°. The camera 40 transmits a captured image to the object detection apparatus 1. For example, the camera 40 is a complementary metal oxide semiconductor (CMOS) camera or a charge coupled device (CCD) camera.

The motor 50 is a control device that performs driving control to change the direction in which the camera 40 is turned. The motor 50 is a servo motor, for example.

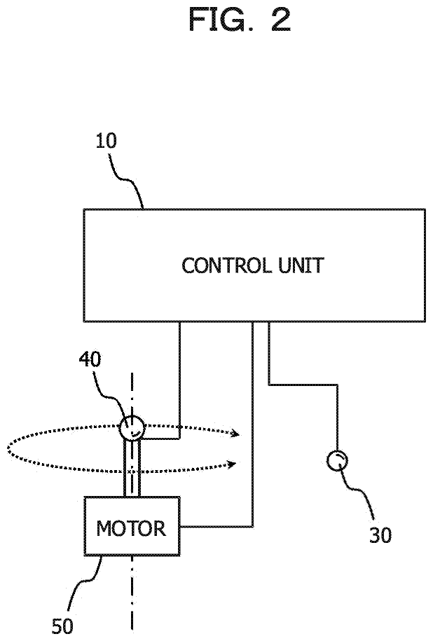

FIG. 2 is a second diagram illustrating an example of the object detection apparatus according to the first embodiment. As illustrated in FIG. 2, the control unit 10 is connected with the sensor 30, the camera 40 and the motor 50, and the motor 50 is connected with the camera 40. The motor 50 rotates the body of the camera 40 about a predetermined rotational axis indicated by alternate long and short dashed lines so that a part of the camera 40 directing toward a subject is changed by 360°. The rotational axis of the camera 40 may not be vertical to the ground but may be parallel to the ground, for example.

Next, functional blocks of the control unit 10 will be described. As illustrated ion FIG. 1, the control unit 10 includes a first storage unit 11, a second storage unit 12, a trigger receiving unit 13, an entry extracting unit 14, a deciding unit 15, a direction categorizing unit 16, a direction determining unit 17, a camera control unit 18, an object detecting unit 19, and an entry registering unit 20. Functions of the units will be described below.

The first storage unit 11 stores a program to be executed by the object detection apparatus 1.

The second storage unit 12 stores information to be used by a process to be executed by the object detection apparatus 1. The second storage unit 12 stores a reference information table 121 and a direction counter 122, for example. The reference information table 121 and the direction counter 122 are used for estimating a direction in which there is a high possibility that a human appears. The reference information table 121 and the direction counter 122 will be described in detail below. The reference information table 121 is an example of reference information. The direction to be estimated by the object detection apparatus 1 is an example of a search starting point.

The trigger receiving unit 13 receives, from the sensor 30, a trigger indicating that a change in a surrounding environment has been detected. The trigger is an input signal for notifying that the sensor 30 has detected a change in a surrounding environment.

The entry extracting unit 14 extracts one or more entries corresponding to a time when a trigger is received from the reference information table 121.

The deciding unit 15 executes deciding processes to be performed by the object detection apparatus 1.

The direction categorizing unit 16 categorizes direction information in the one or more entries extracted by the entry extracting unit 14 into one of a predetermined plurality of direction ranges and updates the direction counter 122. Details of the processing by the direction categorizing unit 16 will be described below.

The direction determining unit 17 determines the most highly frequent direction range from the plurality of direction ranges with reference to the direction counter 122. Details of the processing by the direction determining unit 17 will be described below. The direction determining unit 17 is an example of a determining unit.

The camera control unit 18 is connected with the camera 40 and the motor 50 and controls operations by the camera 40 and the motor 50. The camera control unit 18 further has a function of receiving an image from the camera 40 and transferring it to the object detecting unit 19.

The object detecting unit 19 detects the presence of a human from an image received from the camera control unit 18.

If the object detecting unit 19 detects the presence of a human, the entry registering unit 20 registers a new entry including a time when the human is photographed by the camera 40 and the direction of the camera 40 with the reference information table 121.

Next, a hardware configuration of the object detection apparatus 1 will be described.

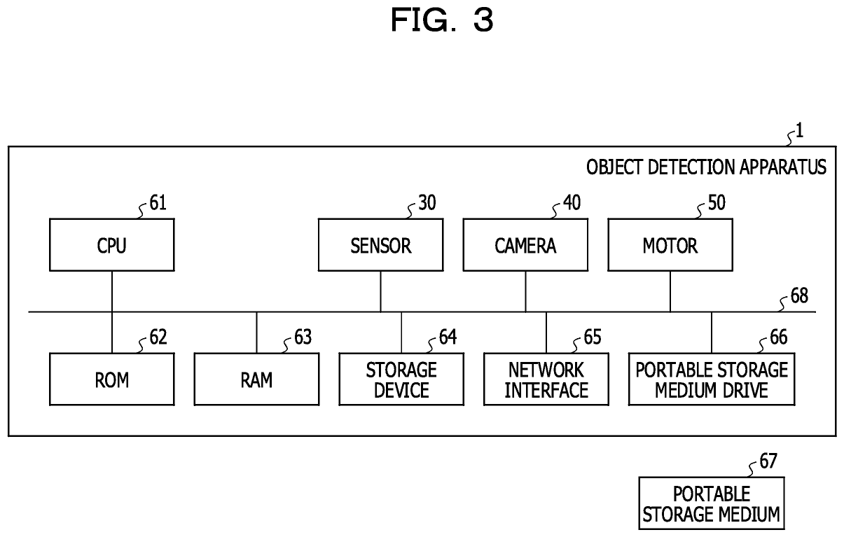

FIG. 3 is a diagram illustrating an example of a hardware configuration of the object detection apparatus according to the first embodiment. As illustrated in FIG. 3, the object detection apparatus 1 includes a central processing unit (CPU) 61, a read only memory (ROM) 62, a random access memory (RAM) 63, a storage device 64, a network interface 65, a portable storage medium drive 66, the sensor 30, the camera 40, and the motor 50, for example. Like numbers refer to like hardware modules in FIG. 1 and FIG. 3, and any repetitive descriptions will be omitted.

The CPU 61 is a hardware module that manages and executes processes in the object detection apparatus 1 and is an example of a processor. As the processor, other processing circuits such as a micro processing unit (MPU) or a digital signal processor (DSP) may be used instead. The CPU 61 is an example of the trigger receiving unit 13, the entry extracting unit 14, the deciding unit 15, the direction categorizing unit 16, the direction determining unit 17, the camera control unit 18, the object detecting unit 19 and the entry registering unit 20 illustrated in FIG. 1.

The ROM 62, the RAM 63, and the storage device 64 are hardware modules that store data and a program to be used for processing to be executed by the CPU 61. The storage device 64 is a hard disk drive (HDD), for example. The ROM 62 and the storage device 64 are examples of the first storage unit 11 illustrated in FIG. 1. The RAM 63 and the storage device 64 are examples of the second storage unit 12 illustrated in FIG. 1.

The network interface 65 is a hardware module for communicating with another apparatus over a network.

The components of the object detection apparatus 1 are connected to a bus 68 such that they may perform data communication with each other via the bus 68. The functionality of the object detection apparatus 1 is implemented by a program stored in the ROM 62 or the storage device 64 or a program read from the portable storage medium 67 by the portable storage medium drive 66 and executed by a processor such as the CPU 61 in the object detection apparatus 1. The program may be loaded to the RAM 63 and be executed by a processor such as the CPU 61.

Next, processing to be executed by the object detection apparatus 1 according to the first embodiment will be described.

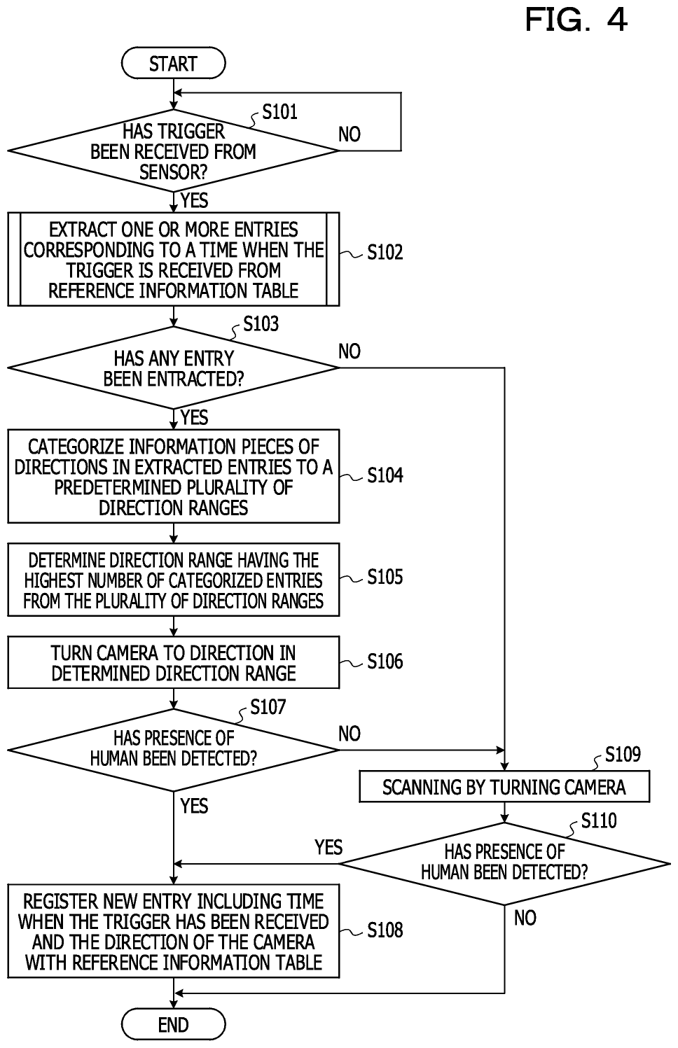

FIG. 4 is a flowchart illustrating an example of processing to be executed by the object detection apparatus according to the first embodiment. First, the deciding unit 15 within the control unit 10 decides whether the trigger receiving unit 13 has received a trigger from the sensor 30 (S101). When a change occurs in a surrounding environment, the sensor 30 may detect the change. For example, in a case where the sensor 30 is a microphone, the sensor 30 may detect a sound. On the other hand, in a case where the sensor 30 is an illuminance sensor, the sensor 30 may detect a change in illuminance. When the sensor 30 detects that a change has occurred in a surrounding environment, the sensor 30 transmits a trigger indicating that a change in the surrounding environment has been detected to the trigger receiving unit 13.

If it is decided that the trigger receiving unit 13 has not received the trigger from the sensor 30 (S101: No), the processing in S101 is executed again. On the other hand, if it is decided that the trigger receiving unit 13 has received the trigger from the sensor 30 (S101: Yes), the entry extracting unit 14 extracts one or more entries corresponding to the time when the trigger has been received from the reference information table 121 stored in the second storage unit 12 (S102).

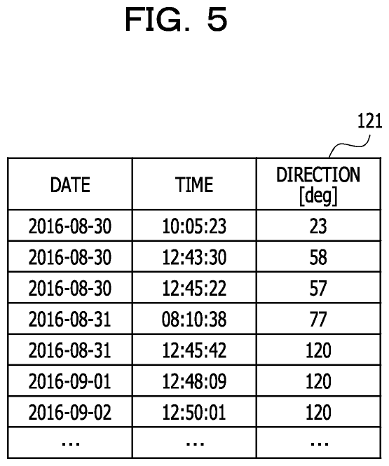

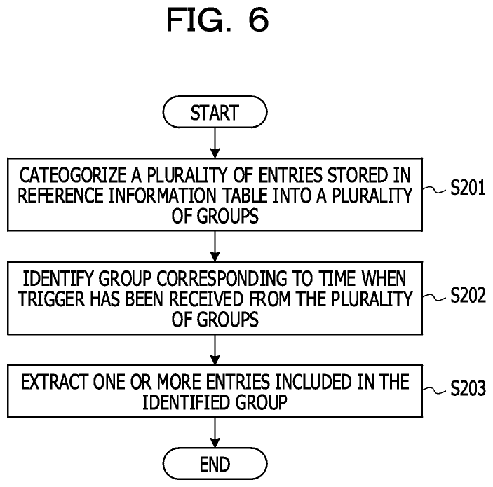

FIG. 5 is a diagram illustrating an example of the reference information table according to the first embodiment. The reference information table 121 is history information (log data) having past histories of detection of a human by the object detection apparatus 1, for example. Every time a human is detected, the object detection apparatus 1 stores attribute information regarding the detection in the reference information table 121 as an entry. As illustrated in FIG. 5, the reference information table 121 has a plurality of entries each including information pieces, in association, of a date when the trigger has been received, a time when the trigger has been received, and a direction of the camera 40 when a human has been detected. For example, in the date item, “2016-08-30” indicates Aug. 30, 2016. In the time item, “10:05:23” indicates ten-five and twenty-three seconds. In the direction item, “23” indicates that the angle of the camera 40 is 23°. The definition of the angle will be described below. Details of the processing in S102 will be described with reference to FIG. 6.

FIG. 6 is a flowchart illustrating details of the processing in S102 according to the first embodiment.

The reference information table 121 may not have an entry including the same time information as the time when the trigger has been received. Accordingly, first, the entry extracting unit 14 categorizes a plurality of entries registered with the reference information table 121 into a plurality of groups (S201). In S201, based on information on times of a plurality of entries, the entries are categorized into a plurality of groups by bringing together entries having a short distance between their times, that is, having a close similarity into one group. The process for bringing together into one group may also be called “clustering”. As the categorization method, any one of various publicly known clustering methods such as a K-means method may be adopted, and any specific method may not be limitedly applied.

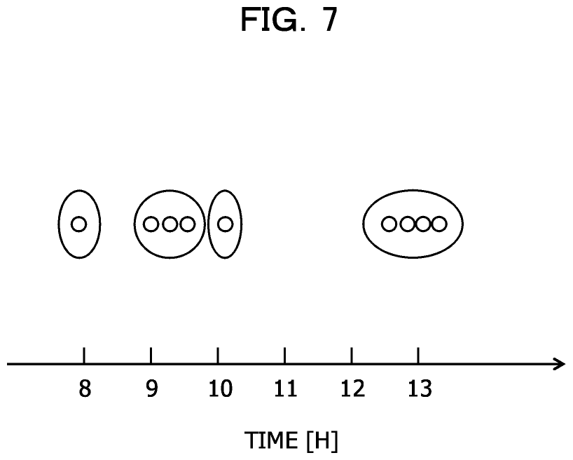

FIG. 7 is a diagram illustrating an example including a plurality of entries that are grouped according to the first embodiment. Each of white circles indicates an entry, and an ellipse around the circle or circles indicates a group. FIG. 7 illustrates an example having nine entries that are categorized into four groups.

Referring back to FIG. 6, after the plurality of entries registered with the reference information table 121 is categorized into a plurality of groups in S201, the entry extracting unit 14 identifies the group corresponding to the time when the trigger has been received from the plurality of groups (S202). In S202, a group to which an entry including a time similar to the time when the trigger has been received belongs is identified from the plurality of groups.

Next, the entry extracting unit 14 extracts one or more entries included in the identified group (S203).

The processing in S102 is executed in the way described above.

Referring back to FIG. 4, after S102, the deciding unit 15 decides whether any entry has been extracted (S103). If no entry has been extracted or if a group corresponding to the time when the trigger has been received has not been identified (S103: No), the processing moves to S109. Details of the processing in S109 will be described below. On the other hand, if it is decided that an entry has been extracted or if a group corresponding to the time when the trigger has been received has been identified (S103: Yes), the direction categorizing unit 16 categorizes the direction information of the extracted entry into one of a predetermined plurality of direction ranges (S104). The direction ranges will be described below.

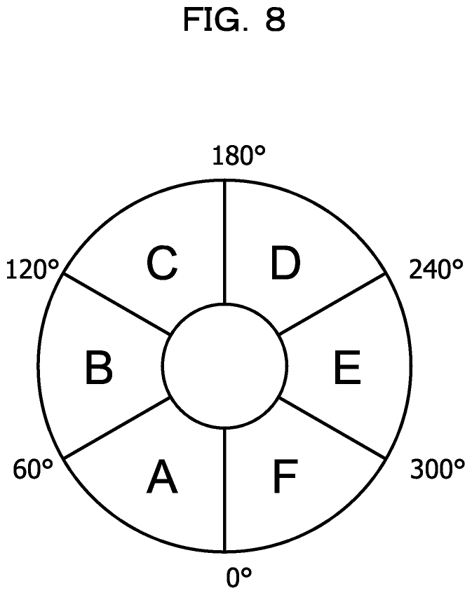

FIG. 8 is a diagram for explaining the direction ranges. As already described above, the camera 40 may be rotated by 360° under control of the motor 50. Thus, the direction of the camera 40 may be represented by an angle within a range from 0° to 360° where a certain direction is defined as 0°. FIG. 8 illustrates an example in which the range of angles from 0° to 360° is divided into six ranges. In the description of embodiments, each of the six ranges is called a “direction range”. The second storage unit 12 pre-stores correspondence information between identification information (A, B, C, D, E, and F) indicating direction ranges and ranges of angles.

Referring back to FIG. 4, in S104, by using the correspondence information, for each of the one or more entries, the direction categorizing unit 16 identifies identification information of a direction range corresponding to information on a direction included in the entry among identification information of the six direction ranges included in the correspondence information. When identification information of a direction range is identified, the direction categorizing unit 16 correspondingly updates the numerical value of the direction counter 122 stored in the second storage unit 12.

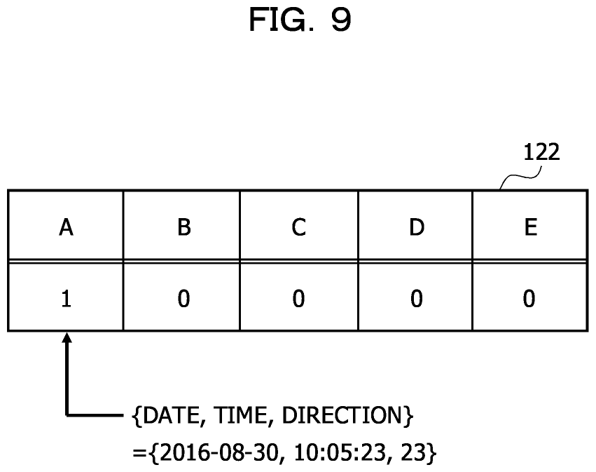

FIG. 9 is a diagram illustrating an example of the direction counter according to the first embodiment. As illustrated in FIG. 9, the direction counter 122 stores numerical values each indicating a frequency of the identification of each identification information of the six direction ranges. For example, an entry including a date “2016-08-30”, a time “10:05:23” and an angle “23”, 23° corresponds to the identification information A of the direction range because 23° is between 0° and 60° with reference to FIG. 8. Then, the direction categorizing unit 16 increments the frequency value corresponding to the identification information A of the direction range within the direction counter 122 and updates it from “0” (not illustrated) to “1”, as illustrated in FIG. 9. This processing is executed for each entry so that frequency information may be acquired for each of the six direction ranges.

Referring back to FIG. 4, after the processing in S104, the direction determining unit 17 determines a direction range with the highest counts of the direction counter 122, that is, a direction range to which the highest number of entries are categorized among the plurality of direction ranges (S105). In S105, the direction determining unit 17 determines the direction range with the highest frequency value among the six direction ranges with reference to the direction counter 122. The determined direction range is a direction which is estimated as having a human by the object detection apparatus 1. In a case where there is a plurality of direction ranges having the highest frequency value, one of the plurality of direction ranges is selected randomly based on a predetermined rule.

Next, the camera control unit 18 turns the camera 40 toward the direction of the determined direction range (S106). More specifically, for example, the camera control unit 18 controls the motor 50 such that the camera 40 turns toward the direction at the angle corresponding to the center of the determined direction range. For example, in a case where the determined direction range is a range from 0° to 60°, the camera control unit 18 controls the motor 50 such that the camera 40 turns toward the direction at 30°.

Next, the deciding unit 15 decides whether the object detecting unit 19 has detected the presence of a human through the camera 40 (S107). In S107, the camera 40 directing toward the determined direction range first captures an image and transmits the captured image to the object detecting unit 19 in the control unit 10. Then, after the object detecting unit 19 receives the image, the object detecting unit 19 checks whether a human is present in the image by using a publicly known pattern for the image.

If the deciding unit 15 decides that the presence of a human has been detected (S107: Yes), the entry registering unit 20 registers a new entry including the time when the trigger has been received and the direction of the camera 40 with the reference information table 121 within the second storage unit 12 (S108). The processing is ended. On the other hand, the deciding unit 15 does not decide that the presence of a human has been detected (S107: No), the camera control unit 18 scans by rotating the camera 40 to search a human in the surrounding (S109).

Next, as a result of the scanning by rotating the camera 40, the deciding unit 15 decides whether the object detecting unit 19 has detected the presence of a human through the camera 40 (S110). If the deciding unit 15 decides that the presence of a human has been detected (S110: Yes), the entry registering unit 20 registers a new entry including the time when the trigger has been received and the direction of the camera 40 with the reference information table 121 within the second storage unit 12 (S108). The processing is ended. On the other hand, if the deciding unit 15 does not decide that the presence of a human has detected (S110: No), it is decided that there is no human in the surrounding, and the processing is ended.

In the manner described above, the object detection apparatus 1 executes the processing that detects a human.

After the processing that detects a human is executed, the object detection apparatus 1 executes a service or an operation for the detected human. For example, in a case where the object detection apparatus 1 is a robot that performs a service such as information provision to a human, the object detection apparatus 1 calls out, communicates information by audio, or displays text information to the detected human.

As a possible problem of an apparatus that detects the presence of a human by using a camera, in a case where the camera includes a general-purpose lens having a limited angle of view, it is difficult to detect a human outside the field of vision if the camera is not moved. This problem may be solved by adopting a wide-angle camera through which an all-around view may be obtained, for example. However, because a wide-angle camera is generally more expensive than a camera having a general-purpose lens, there is a risk that the adoption of a wide-angle camera increases the production cost of the apparatus. On the other hand, as another method, a plurality of cameras having limited angles of views may be provided to solve the problem. However, because the adoption of this method increases the number of cameras to be mounted in the apparatus, there is a risk that the production cost of the apparatus increases.

Contrarily, according to the first embodiment, when a trigger is received from the sensor 30, one or more entries corresponding to the time when the trigger has been received are extracted from the reference information table 121 having a plurality of entries. Based on the information on the directions included in the one or more entries, the direction toward which the camera 40 is to be turned is determined, and the camera 40 is turned toward the direction. If a human is detected through the camera 40, an entry including the time when the trigger has been received and the determined direction is then registered with the reference information table 121. According to this method, even when a camera having a limited angle of view is used, the time for detecting the presence of a human outside the field of vision of the camera may be reduced.

### Second Embodiment

Next, a second embodiment will be described. In the description of the first embodiment, one type of sensor 30 is used, for example. On the other hand, according to the second embodiment, a plurality of types of sensors are used. In the description of the second embodiment, two types of sensors are used as examples of the plurality of types of sensors.

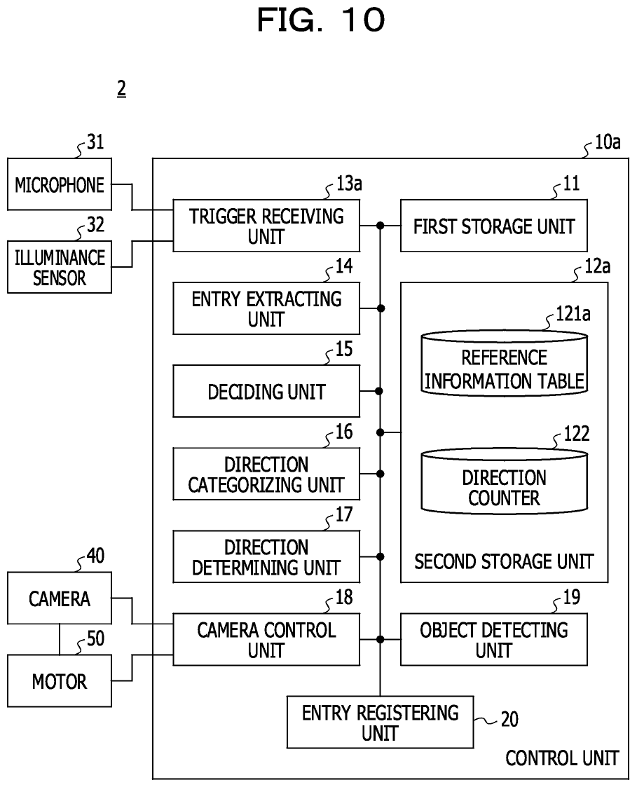

The second embodiment will be described with reference to FIGS. 10 to 16. Like numbers refer to like parts in the first and second embodiments, and any repetitive descriptions will be omitted.

FIG. 10 is a diagram illustrating an example of an object detection apparatus according to the second embodiment. As illustrated in FIG. 10, an object detection apparatus 2 includes a control unit 10a, a microphone 31, an illuminance sensor 32, a camera 40, and a motor 50. The control unit 10a is connected with the microphone 31, the illuminance sensor 32, the camera 40 and the motor 50.

The microphone 31 is a sensor that detects a sound. The illuminance sensor 32 is a sensor that detects a change in brightness. The object detection apparatus 2 may detect a sound or a change in brightness by using the microphone 31 or the illuminance sensor 32 to perceive that a human has approached. The microphone 31 and the illuminance sensor 32 may not have a function that determines the direction in which a human has approached.

The control unit 10a includes a second storage unit 12a instead of the second storage unit 12 illustrated in FIG. 1. The second storage unit 12a has a reference information table 121a instead of the reference information table 121. The control unit 10a includes a trigger receiving unit 13a instead of the trigger receiving unit 13 illustrated in FIG. 1. Like numbers refer to like functional blocks in the first and second embodiments, and any repetitive descriptions will be omitted.

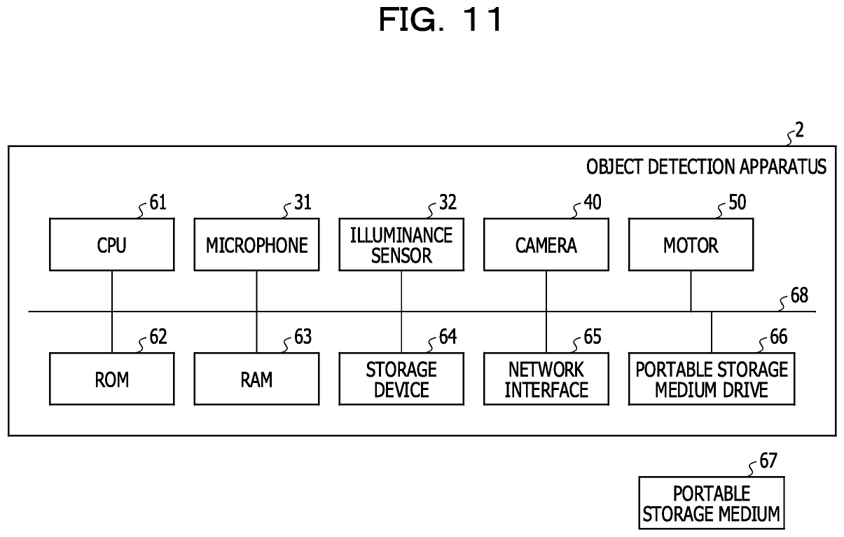

FIG. 11 is a diagram illustrating an example of a hardware configuration of the object detection apparatus according to the second embodiment. As illustrated in FIG. 11, the object detection apparatus 2 includes a CPU 61, a ROM 62, a RAM 63, a storage device 64, a network interface 65, a portable storage medium drive 66, the microphone 31, the illuminance sensor 32, the camera 40, and the motor 50, for example. Like numbers refer to like hardware modules in FIG. 10 and FIG. 11, and any repetitive description will be omitted. The second storage unit 12a is implemented by the RAM 63 and the storage device 64, for example. The trigger receiving unit 13a is implemented by the CPU 61, for example.

Next, processing to be executed by the object detection apparatus 2 will be described.

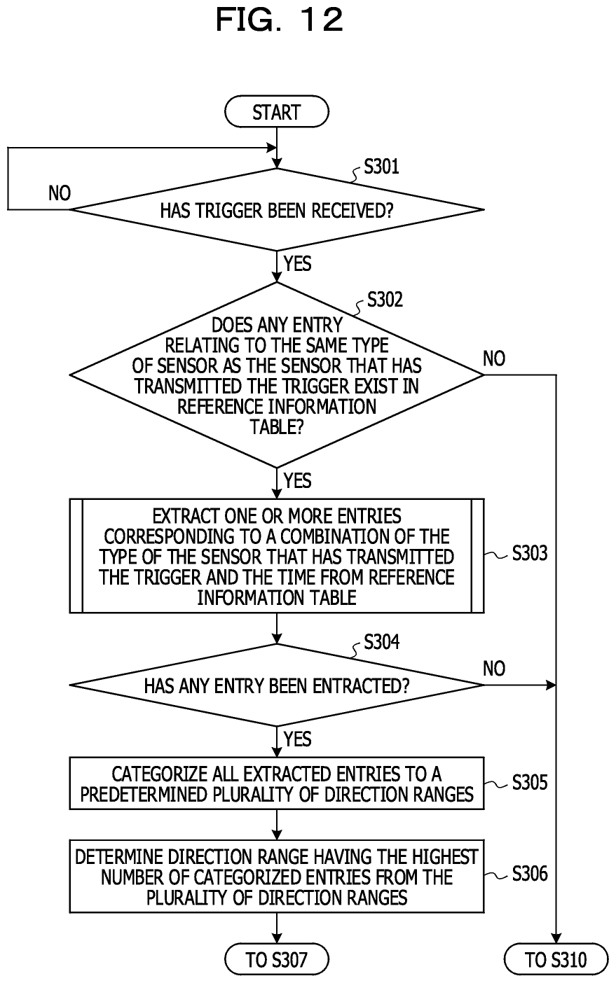

FIG. 12 is a first flowchart illustrating an example of processing to be executed by the object detection apparatus according to the second embodiment. First, the deciding unit 15 within the control unit 10a decides whether the trigger receiving unit 13a has received a trigger from the microphone 31 or the illuminance sensor 32 (S301). When the microphone 31 detects a sound, the microphone 31 transmits a trigger indicating that a sound has been detected to the trigger receiving unit 13a. When the illuminance sensor 32 detects a change in illuminance, the illuminance sensor 32 transmits a trigger indicating that a change in illuminance has been detected to the trigger receiving unit 13a. These triggers include information on the types of sensors. The information on a type of sensor is an example of detection information from a sensor.

If it is decided that the trigger receiving unit 13a has not received the trigger (S301: No), the processing in S301 is executed again. On the other hand, if it is decided that the trigger receiving unit 13a has received the trigger (S301: Yes), the deciding unit 15 decides whether any entry relating to the same type of sensor as the sensor that has transmitted the trigger exists within the reference information table 121a (S302).

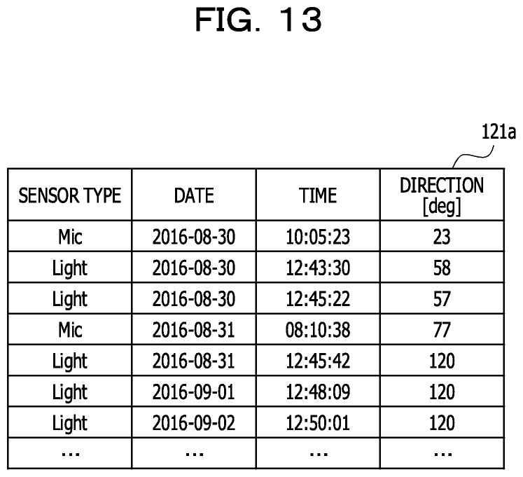

FIG. 13 is a diagram illustrating an example of the reference information table according to the second embodiment. As illustrated in FIG. 13, the reference information table 121a has a plurality of entries each including information pieces of a sensor type indicating a type of sensor, a date when the sensor has detected an environmental change, a time when the sensor has detected the environmental change, and a direction in which a human has been detected in association. In the item of the sensor type, “Mic” refers to the microphone 31, and “Light” refers to the illuminance sensor 32.

Referring back to FIG. 12, in S302, the deciding unit 15 first extracts information on the type of the sensor from the received trigger. If the extracted type of the sensor is the microphone, the deciding unit 15 decides whether any entry including information on the microphone exists in the reference information table 121a. If the extracted type of the sensor is the illuminance sensor, the deciding unit 15 decides whether any entry including information on the illuminance sensor exists in the reference information table 121a.

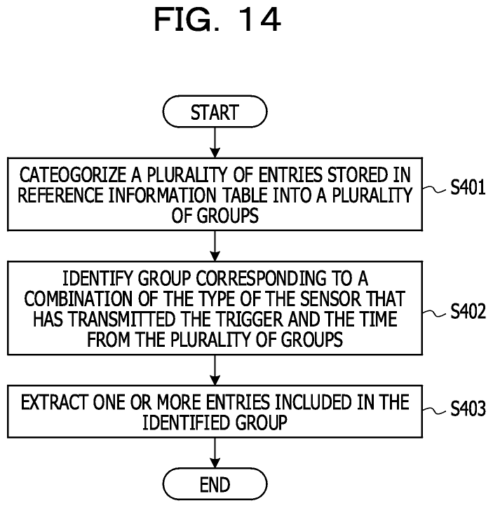

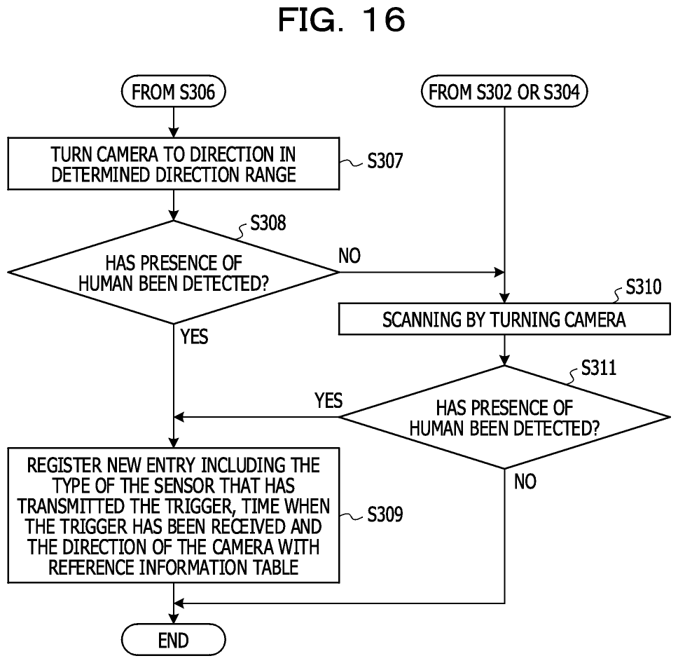

If it is not decided that an entry relating to the same type of the sensor as the sensor that has transmitted the trigger exists in the reference information table 121a (S302: No), the processing moves to S310 in FIG. 16. On the other hand, if it is decided that an entry or entries relating to the same type of the sensor as the sensor that has transmitted the trigger exists in the reference information table 121a (S302: Yes), the entry extracting unit 14 extracts one or more entries corresponding to a combination of the type of the sensor that has transmitted the trigger and the time from the reference information table 121a (S303). Details of the processing in S303 will be described with reference to FIG. 14.

FIG. 14 is a flowchart illustrating details of the processing in S303 according to the second embodiment.

The reference information table 121a may not have an entry including the same time information as the time when the trigger has been received. Accordingly, first, the entry extracting unit 14 categorizes a plurality of entries stored in the reference information table 121a into a plurality of groups (S401). In S401, based on information on types of sensors and times of a plurality of entries, the entries are categorized into a plurality of groups by bringing together entries having the same type of sensor and a short distance between times, that is, having a close similarity into one group. As the categorization method, any one of various publicly known clustering methods may be adopted, and any specific method is not limitedly applied.

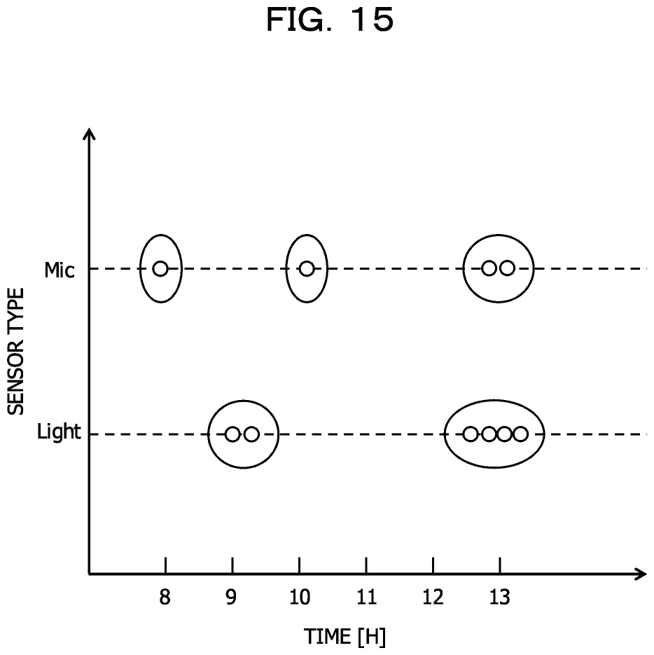

FIG. 15 is a diagram illustrating an example including a plurality of entries that are grouped according to the second embodiment. Each of white circles indicates an entry, and an ellipse around the circle or circles indicates a group. On the vertical axis, “Mic” refers to the microphone 31, and “Light” refers to the illuminance sensor 32. FIG. 15 illustrates an example having ten entries that are categorized into five groups.

Referring back to FIG. 14, after the plurality of entries stored in the reference information table 121a is categorized into a plurality of groups in S401, the entry extracting unit 14 identifies the group corresponding to a combination of the type of the sensor that has transmitted the trigger and the time from the plurality of groups (S402). In S402, a group containing a combination of the type of the sensor that has transmitted the trigger and the time when the trigger has been received is identified from the plurality of groups.

Next, the entry extracting unit 14 extracts one or more entries included in the identified group (S403).

The processing in S303 is executed in the way described above.

Referring back to FIG. 12, after S303, the deciding unit 15 decides whether any entry has been extracted (S304). If no entry has been extracted or if a group corresponding to a combination of the type of the sensor that has transmitted the trigger and the time has not been identified (S304: No), the processing moves to S310 in FIG. 16. Details of the processing in S310 will be described below. On the other hand, if an entry has been extracted or if a group corresponding to the combination of the type of the sensor that has transmitted the trigger and the time has been identified (S304: Yes), the direction categorizing unit 16 categorizes all of the extracted entries into a predetermined plurality of direction ranges (S305). Because the direction range is the same as the direction range according to the first embodiment, any repetitive descriptions will be omitted. For the entry categorization, a counter similar to the direction counter 122 according to the first embodiment may be used. The processing in S305 is the same as the processing in S104 according to the first embodiment.

After the processing in S305, the direction determining unit 17 determines a direction range with the highest count of the direction counter 122, that is, a direction range to which the highest number of entries are categorized among the plurality of direction ranges (S306). The processing in S306 is the same as the processing in S105 according to the first embodiment. After the processing in S306, the processing moves to S307 in FIG. 16.

FIG. 16 is a second flowchart illustrating an example of processing to be executed by the object detection apparatus according to the second embodiment.

After the processing in S306 illustrated in FIG. 12, the camera control unit 18 turns the camera 40 toward the direction of the determined direction range (S307). The processing in S307 is the same as the processing in S106 according to the first embodiment.

Next, the deciding unit 15 decides whether the object detecting unit 19 has detected the presence of a human through the camera 40 (S308). The processing in S308 is the same as the processing in S107 according to the first embodiment.

If the deciding unit 15 decides that the presence of a human has been detected (S308: Yes), the entry registering unit 20 registers a new entry including the type of the sensor that has transmitted the trigger, the time when the trigger has been received and the direction of the camera 40 with the reference information table 121 within the second storage unit 12 (S309). The processing is ended. On the other hand, the deciding unit 15 does not decide that the presence of a human has been detected (S308: No), the camera control unit 18 scans by rotating the camera 40 to search a human in the surrounding (S310). The processing in S310 is the same as the processing in S109 according to the first embodiment.

Next, as a result of the scanning by rotating the camera 40, the deciding unit 15 decides whether the object detecting unit 19 has detected the presence of a human through the camera 40 (S311). The processing in S311 is the same as the processing in S110 according to the first embodiment. If the deciding unit 15 decides that the presence of a human has been detected (S311: Yes), the entry registering unit 20 executes the processing in S309 above, and the processing is ended. On the other hand, if the deciding unit 15 does not decide that the presence of a human has detected (S311: No), it is decided that there is no human in the surrounding, and the processing is ended.

In the manner described above, the object detection apparatus 2 executes the processing that detects a human.

After the processing that detects a human is executed, the object detection apparatus 2 executes a service or an operation as illustrated in the description of the first embodiment for the detected human.

Because a human turns on an illumination apparatus in the night time zone, a human may press a switch for the illumination apparatus placed near a door, for example. At that time, the illuminance sensor 32 detects a change in illuminance, and the object detection apparatus 2 then may detect the presence of a human present in the direction having the door through the camera 40.

There is a high possibility that a human relaxing on a sofa placed in a living room in the night time zone makes a sound at a place where the sofa is placed. In this case, the microphone 31 detects the occurrence of the sound, and the object detection apparatus 2 then may detect the presence of a human in the direction having the sofa through the camera 40.

There is a high possibility that a human having breakfast in the morning time zone makes a sound near a table placed in a dining room. In this case, the microphone 31 detects the sound, and the object detection apparatus 2 then may detect the presence of a human in the direction having the table through the camera 40.

In this manner, the relationship between the type of sensor that detects an environmental change and the direction has a certain tendency in accordance with the time zone.

The second embodiment uses the tendency and executes the processing that detects a human by taking the opportunity of reception of a trigger transmitted from one of a plurality of sensors of different types such as the microphone 31 and the illuminance sensor 32. According to this method, because entry candidates may be narrowed in accordance with the type of the sensor that has transmitted a trigger, the precision for estimating the direction having a human may be enhanced.

According to the second embodiment, the trigger to be transmitted from the microphone 31 or the illuminance sensor 32, for example, to the trigger receiving unit 13a includes information on the type of the sensor. However, embodiments are not limited thereto. For example, in a case where the microphone 31 and the illuminance sensor 32 are connected with the trigger receiving unit 13a through different interfaces (such as software interfaces and hardware interfaces), the type of the sensor that has transmitted a trigger may be determined based on the interface from which the trigger has been received. With this configuration, the trigger transmitted from a sensor may not include information on the type of the sensor, but the trigger receiving unit 13a may include information indicating the type of the sensor in the trigger in accordance with the interface from which the trigger has been received.

### Third Embodiment

Next, a third embodiment will be described. According to the second embodiment, an entry corresponding to a combination of the type of a sensor that has transmitted a trigger and a time when the trigger has been received is extracted from the reference information table 121a. According to the third embodiment on the other hand, all entries relating to the same type of sensor as that of the sensor that has transmitted a trigger are extracted from a reference information table without consideration of times.

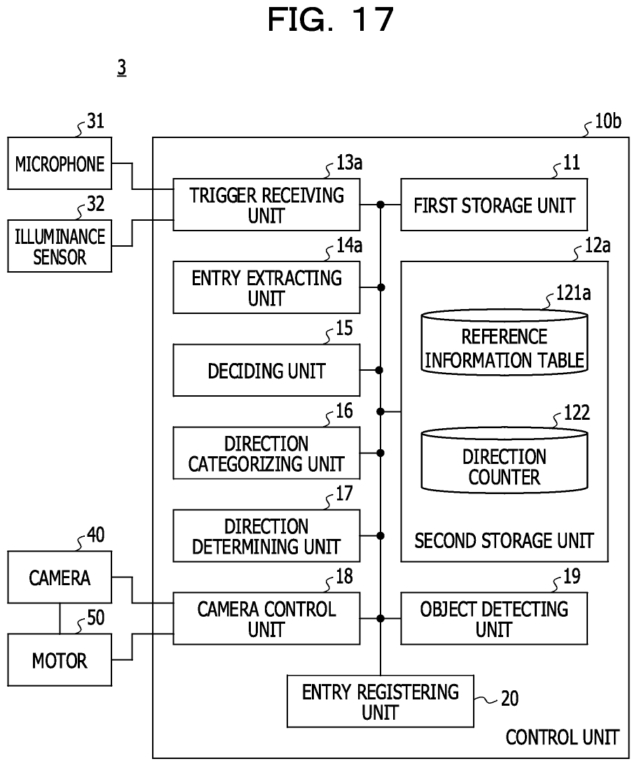

The third embodiment will be described with reference to FIGS. 17 to 20. Like numbers refer to like parts in the second and third embodiments, and any repetitive descriptions will be omitted.

FIG. 17 is a diagram illustrating an example of an object detection apparatus according to the third embodiment. As illustrated in FIG. 17, an object detection apparatus 3 includes a control unit 10b, a microphone 31, an illuminance sensor 32, a camera 40, and a motor 50. The control unit 10b is connected with the microphone 31, the illuminance sensor 32, the camera 40 and the motor 50.

The control unit 10b includes an entry extracting unit 14a instead of the entry extracting unit 14 illustrated in FIG. 12. Because the components excluding the control unit 10b are the same as those of the second embodiment, like numbers refer to like components. Therefore, any repetitive descriptions will be omitted.

Because the hardware configuration of the object detection apparatus 3 according to the third embodiment is the same as the hardware configuration of the object detection apparatus 2 according to the second embodiment illustrated in FIG. 11, any repetitive descriptions will be omitted. The entry extracting unit 14a is implemented by the CPU 61, for example.

Next, processing to be executed by the object detection apparatus 3 will be described.

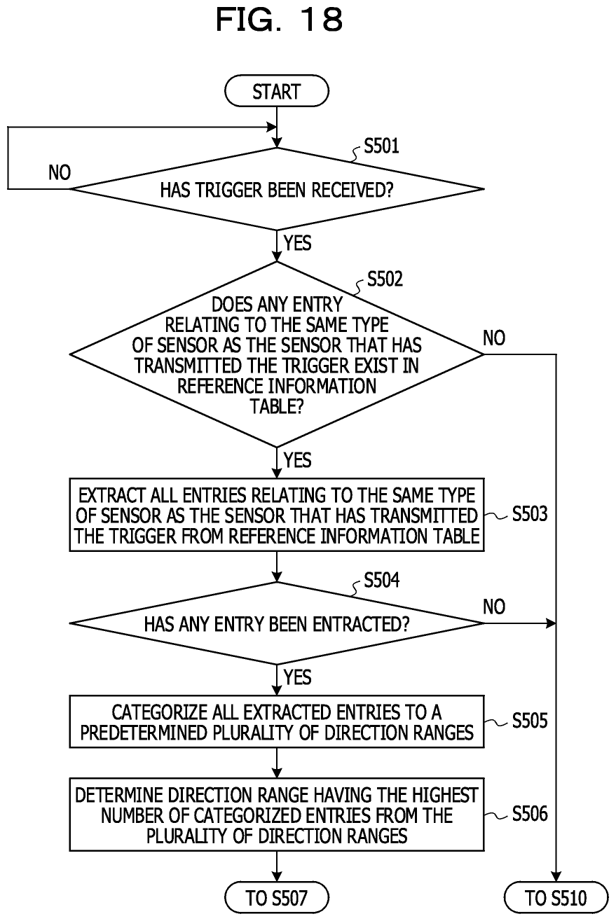

FIG. 18 is a first flowchart illustrating an example of processing to be executed by the object detection apparatus according to the third embodiment. First, the deciding unit 15 within the control unit 10b decides whether the trigger receiving unit 13a has received a trigger from the microphone 31 or the illuminance sensor 32 (S501). The processing in S501 is the same as the processing in S301 according to the second embodiment.

If it is decided that the trigger receiving unit 13a has not received a trigger (S501: No), the processing in S501 is executed again. On the other hand, if it is decided that the trigger receiving unit 13a has received a trigger (S501: Yes), the deciding unit 15 decides whether any entry relating to the same type of sensor as the sensor that has transmitted the trigger exists within the reference information table 121a (S502). The processing in S502 is the same as the processing in S302 according to the second embodiment.

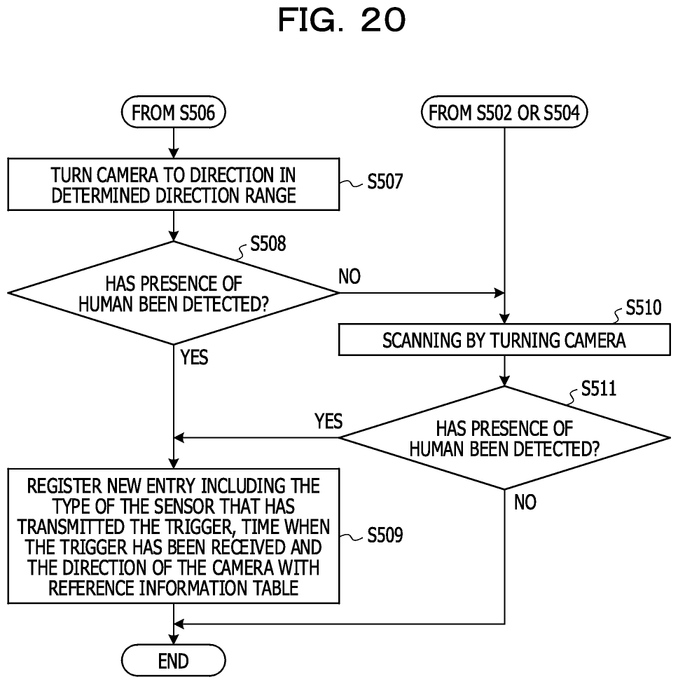

If it is not decided that an entry relating to the same type of the sensor as the sensor that has transmitted the trigger exists in the reference information table 121a (S502: No), the processing moves to S510 in FIG. 20. On the other hand if it is decided that an entry or entries relating to the same type of the sensor as the sensor that has transmitted the trigger exists in the reference information table 121a (S502: Yes), the entry extracting unit 14a extracts all entries relating to the same type of the sensor as the sensor that has transmitted the trigger from the reference information table 121a (S503). The reference information table 121a according to the third embodiment at least has a plurality of entries each including information pieces of a sensor type and a direction in association. Accordingly, the entry extracting unit 14a in S503 extracts all entries including the same sensor type as the type of the sensor that has transmitted the trigger from the plurality of entries.

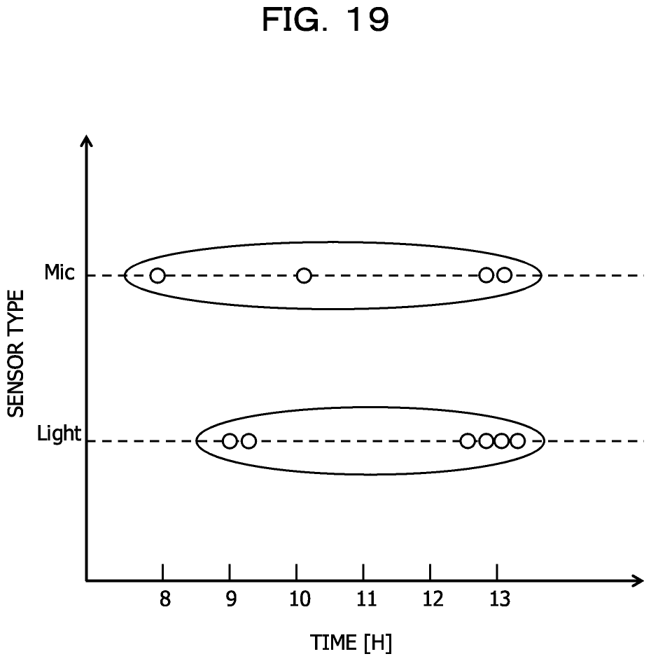

FIG. 19 is a diagram illustrating an example including a plurality of entries that are grouped according to the third embodiment. Each of white circles indicates an entry, and an ellipse around the circle or circles indicates a group. For convenience of illustration, FIG. 19 assumes that the reference information table 121a according to the third embodiment also has time information as illustrated in FIG. 13 and has time on its horizontal axis. As illustrated in FIG. 19, the plurality of entries is categorized into one of a group whose sensor type is the microphone and a group whose sensor type is the illuminance sensor. In the example in FIG. 19, four entries are categorized into the group whose sensor type is the microphone, and six entries are categorized into the group whose sensor type is the illuminance sensor. If the type of the sensor that has transmitted the trigger is the microphone, the four entries belonging to the group whose sensor type is the microphone are extracted by the entry extracting unit 14a in S503.

Referring back to FIG. 18, after S503, the deciding unit 15 decides whether an entry has been extracted (S504). If no entry has been extracted or if a group corresponding to the combination of the type of the sensor that has transmitted the trigger and the time has not been identified (S504: No), the processing moves to S510 in FIG. 20. Details of the processing in S510 will be described below. On the other hand, if entries have been extracted or if a group corresponding to the combination of the type of the sensor that has transmitted the trigger and the time has been identified (S504: Yes), the direction categorizing unit 16 categorizes all of the extracted entries into a predetermined plurality of direction ranges (S505). Because the processing in S505 is the same as the processing in S305 according to the second embodiment, any repetitive detail descriptions will be omitted.

After the processing in S505, the direction determining unit 17 determines a direction range to which the highest number of entries are categorized among the plurality of direction ranges (S506). The processing in S506 is the same as the processing in S306 according to the second embodiment. After the processing in S506, the processing moves to S507 in FIG. 20.

FIG. 20 is a second flowchart illustrating an example of processing to be executed by the object detection apparatus according to the third embodiment.

After the processing in S506 illustrated in FIG. 18, the camera control unit 18 turns the camera 40 toward the direction of the determined direction range (S507). Because the processing from S507 to S511 is the same as the processing from S307 to S311 according to the second embodiment illustrated in FIG. 16, any repetitive descriptions will be omitted.

In the manner described above, the object detection apparatus 3 executes the processing that detects a human.

After the processing that detects a human is executed, the object detection apparatus 3 executes a service or an operation as illustrated in the description of the first embodiment for the detected human.

For example, there is a possibility that the direction in which the microphone 31 easily detects a sound is limited. For example, a case is assumed in which, about the position where the object detection apparatus 3 is placed, lumber is used for a floor in the direction at 0° and a carpet is used for a floor in the direction at 180°. In this case, because more sounds occur when a human walks on the lumber than the carpet, there may be a high possibility that the source of the sound detected by the microphone 31 if any is in the direction at 0° rather than the direction at 180°.

In this way, there may be a certain tendency between the sensor types and the directions.

The third embodiment uses the tendency, and all related entries are extracted and are grouped based on the sensor types included in the entries without consideration of the times detected by the sensors. According to this method, because entry candidates may be narrowed in accordance with the type of the sensor that has transmitted a trigger and the number of groups to be generated is lower than that of the second embodiment, the time for the processing that detects a human may be reduced.

### Fourth Embodiment

Next, a fourth embodiment will be described. According to the first to third embodiments, a plurality of entries registered with the reference information table is clustered into a plurality of groups. Then, a group corresponding to information of a trigger is selected from the plurality of groups, and the direction having a human is estimated. According to the fourth embodiment on the other hand, a machine learning algorithm is used to analyze information registered with a reference information table so that the direction having a human may be estimated.

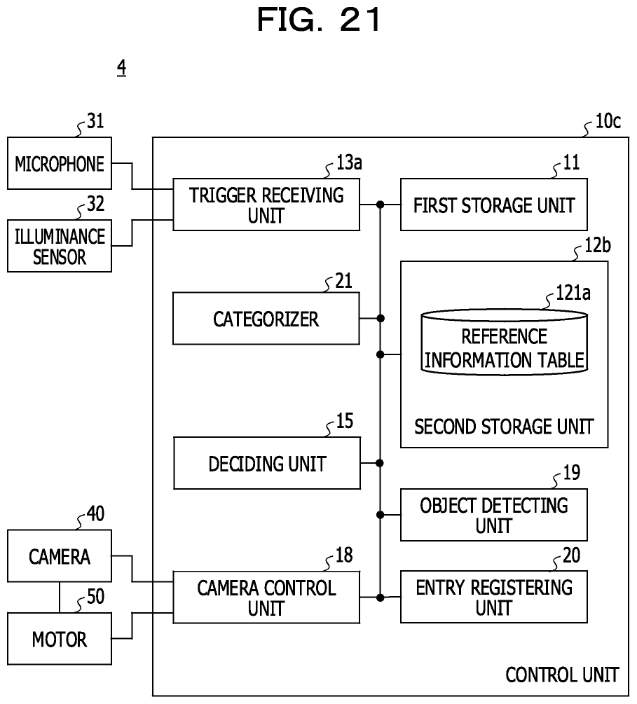

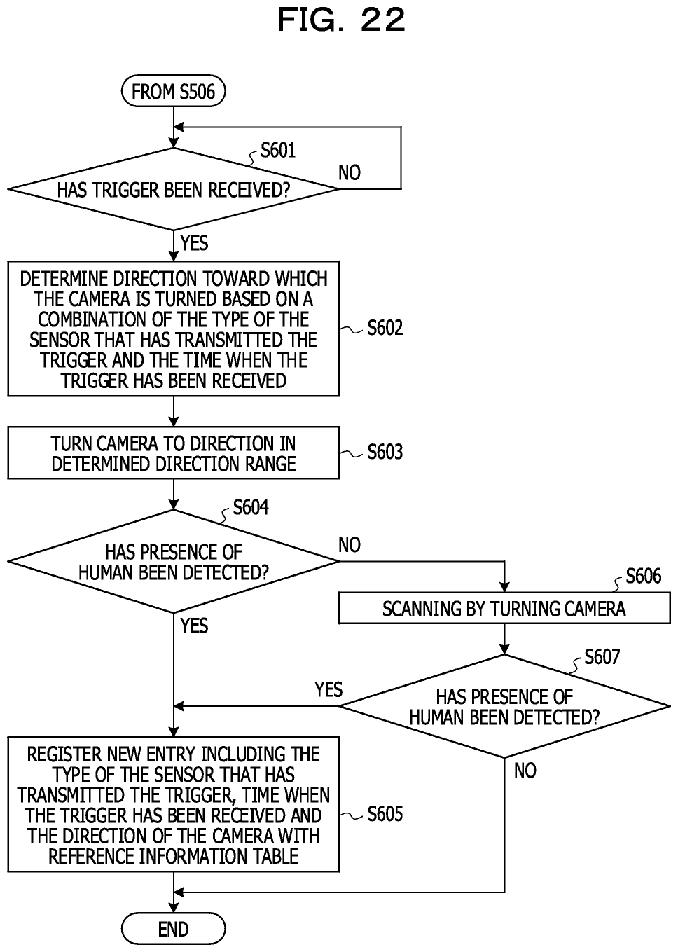

The fourth embodiment will be described with reference to FIGS. 21 to 22.

FIG. 21 is a diagram illustrating an example of an object detection apparatus according to the fourth embodiment. As illustrated in FIG. 21, an object detection apparatus 4 includes a control unit 10c, a microphone 31, an illuminance sensor 32, a camera 40, and a motor 50. The control unit 10c is connected with the microphone 31, the illuminance sensor 32, the camera 40 and the motor 50. Because the components excluding the control unit 10c are the same as those of the second or third embodiment, like numbers refer to like components. Therefore, any repetitive descriptions will be omitted.

Next, functional blocks of the control unit 10c will be described. The control unit 10c includes a first storage unit 11, a second storage unit 12b, a trigger receiving unit 13a, a deciding unit 15, a camera control unit 18, an object detecting unit 19, an entry registering unit 20, and a categorizer 21. Like numbers refer to like functional blocks in the second or third and fourth embodiments, and any repetitive descriptions will be omitted.

The second storage unit 12b has a reference information table 121a, like the second storage unit 12a. However, the second storage unit 12b does not have the direction counter 122.

The categorizer 21 receives input of the trigger type of the source of a trigger received by the trigger receiving unit 13a, the date and the time. The categorizer 21 then analyzes information in the reference information table 121a by using a machine learning algorithm and, based on the result of the analysis, outputs the direction corresponding to the input information as a result of estimation of the direction having a human. By using the categorizer 21, the direction counter 122, the direction categorizing unit 16 and the direction determining unit 17 are not required.

Because the hardware configuration of the object detection apparatus 4 is the same as the hardware configuration of the object detection apparatus 2 according to the second embodiment illustrated in FIG. 11, any repetitive descriptions will be omitted. The second storage unit 12b is implemented by the RAM 63 and the storage device 64, for example. The categorizer 21 is implemented by the CPU 61, for example.

Next, processing to be executed by the object detection apparatus 4 will be described.

FIG. 22 is a flowchart illustrating an example of processing to be executed by the object detection apparatus according to the fourth embodiment. First, the deciding unit 15 within the control unit 10c decides whether the trigger receiving unit 13a has received a trigger from the microphone 31 or the illuminance sensor 32 (S601). The processing in S601 is the same as the processing in S301 according to the second embodiment.

If it is decided that the trigger receiving unit 13a has not received a trigger (S601: No), the processing in S601 is executed again. On the other hand, if it is decided that the trigger receiving unit 13a has received a trigger (S601: Yes), the categorizer 21 determines the direction to which the camera 40 is to be turned based on the combination of the sensor type of the source of the trigger and the time when the trigger has been received (S602). More specifically, for example, when the trigger receiving unit 13a receives a trigger, information on the sensor type of the source of the trigger and the time when the trigger has been received is input to the categorizer 21. The categorizer 21 analyzes information registered with the reference information table 121a by using a publicly known machine learning algorithm. The categorizer 21 then finds a tendency pattern of the direction corresponding to the combination of the sensor type and the time when the trigger has been received. After that, the categorizer 21 determines the direction corresponding to the combination of the input sensor type and the time when the trigger has been received and outputs the information on the determined direction to the camera control unit 18.

After the processing in S602, the camera control unit 18 turns the camera 40 toward the direction of the determined direction range (S603). Because the processing from S603 to S607 is the same as the processing from S307 to S311 according to the second embodiment illustrated in FIG. 16, any repetitive descriptions will be omitted.

In the manner described above, the object detection apparatus 4 executes the processing that detects a human.

After the processing that detects a human is executed, the object detection apparatus 4 executes a service or an operation as illustrated in the description of the first embodiment for the detected human.

According to the fourth embodiment, a machine learning algorithm is used to analyze information registered with the reference information table so that the direction having a human may be estimated. According to this method, because the processing that determines the direction toward which the camera is turned is simplified, the time for the processing that detects a human may be reduced.

Although the preferred embodiments have been described in detail above, embodiments are not limited to the specific embodiments, and various modifications and changes may be made. For example, according to the first to fourth embodiments, the trigger receiving unit registers the time when a trigger has been received under the item of time in a reference information table. However, such a trigger may include information on a time when an environmental change has been detected, and the time may be registered under the item of time in the reference information table.

Although the microphone 31 and the illuminance sensor 32 are illustrated as types of sensors included in the object detection apparatus according to the second to fourth embodiments, other types of sensors such as a vibration sensor that detects a vibration may be used.

Although, according to the first to fourth embodiments, the object detection apparatus executes the processing that detects a human based on an image transmitted from the camera 40, the camera 40 itself may execute the processing.

Although, according to the first to fourth embodiments, a direction is presented as a search starting point, positional coordinates defined by a predetermined coordinate system may be handled as a search starting point.

The object detection apparatus according to the first to fourth embodiments may perform the processing that determines a search starting point described above by taking the opportunity of detection of an environmental change by a sensor while a search for a human is being continuously performed by using the camera.

Although, according to the second embodiment, the illuminance sensor 32 transmits a trigger to the trigger receiving unit 13a when detecting a change in illuminance, an illuminance measured value may be transmitted to the control unit 10a as detection information from the illuminance sensor 32, and the control unit 10a having received the illuminance measured value may compare it with a predetermined threshold value to decide that the illuminance has been changed.

Having described that, according to the first to third embodiments, a reference information table being history information is used as an example of the reference information table, a user of the object detection apparatus may preset a correspondence relationship between at least one of time and detection information and the direction in which an object has been detected based on history information, for example, and the set information may be used as the reference information.

A computer program causing a computer to execute the aforementioned object detection apparatus and object detection method and a non-transitory computer-readable recording medium recording the program are included in the scope of embodiments. The non-transitory computer-readable recording medium is a memory card such as an SD memory card. The computer program is not limited to one recorded in the recording medium but may be transmitted through an electric communication line, a wireless or wired communication line or a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An object detection apparatus comprising:
a camera configured to capture an image of an object;
one or more of sensor devices, each of the one or more of sensor devices being configured to detect an environmental change; and
a processor configured to
execute a determining process that includes, in a case where any one of the one or more of sensor devices detects an environmental change, detecting a search starting point of the object based on at least one of a time corresponding to the detection and detection information from the sensor device, the search starting point corresponding to a direction toward which the camera is turned,
execute an entry registering process that includes registering an entry with reference information when the object is detected, the entry including at least one of the time and the detection information and a direction in which the object is detected,
wherein the determining process is configured to determine the direction toward which the camera is to be turned based on the reference information.

2. The object detection apparatus according to claim 1,
wherein the processor is configured to
execute a search control process that includes starting a search for an object from the determined search starting point.

3. The object detection apparatus according to claim 1,
wherein the processor is configured to
execute an entry extracting process that includes
categorizing a plurality of the entries registered with the reference information into a plurality of groups based on at least one of the time and the detection information, and
identifying a group corresponding to at least one of the time and the detection information from the plurality of groups, and
wherein the determining process is configured to determine the direction toward which the camera is to be turned based on information on the direction included in the identified group.

4. The object detection apparatus according to claim 3,
wherein the processor is configured to
execute a direction categorizing process that includes direction information pieces included in the identified group into a predetermined plurality of direction ranges, and
wherein the direction determining process is configured to determine a direction range having the highest number of categorized entries from the plurality of direction ranges.

5. The object detection apparatus according to claim 1,
wherein the determining process is configured to determine the direction toward which the camera is to be turned by analyzing information registered with the reference information by using a machine learning algorithm.

6. A control method implemented by an object detection apparatus having a camera configured to capture an image of an object, and one or more of sensor devices each of which is configured to detect an environmental change, the method comprising:
executing a determining process that includes, in a case where any one of the one or more of sensor devices detects an environmental change, detecting a search starting point of the object based on at least one of a time corresponding to the detection and detection information from the sensor device, the search starting point corresponding to a direction toward which the camera is turned,
executing an entry registering process that includes registering an entry with reference information when the object is detected, the entry including at least one of the time and the detection information and a direction in which the object is detected,
wherein the determining process is configured to determine the direction toward which the camera is to be turned based on the reference information.

7. A non-transitory computer-readable storage medium storing a program which causes a computer to perform processing, the computer having a camera configured to capture an image of an object, and one or more of sensor devices each of which is configured to detect an environmental change, the processing comprising:
executing a determining process that includes, in a case where any one of the one or more of sensor devices detects an environmental change, detecting a search starting point of the object based on at least one of a time corresponding to the detection and detection information from the sensor device, the search starting point corresponding to a direction toward which the camera is turned,
executing an entry registering process that includes registering an entry with reference information when the object is detected, the entry including at least one of the time and the detection information and a direction in which the object is detected,
wherein the determining process is configured to determine the direction toward which the camera is to be turned based on the reference information.
